(19) United States
(12) Patent Application Publication
(10) Pub. No.: US 2004/0216171 A1
(43) Pub. Date: Oct. 28, 2004

(54) Remote monitoring system and method for interactive television data

(75) Inventors: Samuel T. Barone JR., Culver City, CA (US); John Kelly King, Longwood, CA (US)

Correspondence Address: CHRISTIE, PARKER & HALE, LLP, PO BOX 7068, PASADENA, CA, 91109-7068, US

(73) Assignee: Goldpocket Interactive

(21) Appl. No.: 10/850,092

(22) Filed: May 20, 2004

Related U.S. Application Data
(63) Continuation of application No. 10/222,704, filed on Aug. 16, 2002.
(60) Provisional application No. 60/312,925, filed on Aug. 16, 2001.

(51) Int. Cl. H04N 7/173; H04N 7/16; H04N 7/00; H04N 11/00

(52) U.S. Cl. 725/135; 348/468; 725/110; 725/109; 725/136

(57) ABSTRACT

An ITV system that monitors and stores data related to digital video broadcasts. Such data may include digital sound files, image files, subscription data, software programs, television program information, ITV advertising content, and the like. The monitoring system stores information about a pre-determined set of data that is being monitored in a digital video stream, in one or more log files. The log files may then be used to generate a plurality of user defined reports. The reports may be used by broadcasters, cable operators, and content providers, and the like to establish general auditing and billing services.

### CROSS-REFERENCE TO RELATED APPLICATION(S)

This application is a continuation of application Ser. No. 10/222,704, filed Aug. 16, 2002, which claims the benefit of U.S. application Ser. No. 60/312,925 (attorney docket 45365/JEC/M770), filed on Aug. 16, 2001, the content of which is incorporated herein by reference.

### FIELD OF THE INVENTION

The present invention is generally directed to an interactive television (ITV) system and more particularly, to an ITV system that monitors and stores data related to digital video broadcasts.

### BACKGROUND OF THE INVENTION

Traditional television broadcasts include analog video signals that are received by a television antenna, cable set-top-box, satellite receiver, and the like. A particular video signal may include data such as, for example, closed captioning data and interactive television data, generally embedded in the vertical blanking interval (VBI) of the video signal. A transmitting head end may monitor and log data that is transmitted in the VBI for establishing general auditing and billing services.

A next generation type of televisions that are becoming increasingly popular are digital televisions such as, for example, high-definition televisions (HDTV), configured to receive and decode digital video signals. Transmitted along with such digital video signals are different types of digital data that may be desirable for a head end to log and monitor. Such information may be used for billing, financial accounting, and/or other distribution needs. Traditional analog video monitoring systems, however, do not provide the capability of monitoring digital video data. Accordingly, what is desired is a system for monitoring and logging digital data transmitted with digital video feeds.

### SUMMARY OF THE INVENTION

The present invention is directed to an ITV system that monitors and stores data related to digital video broadcasts. According to one embodiment of the invention, the invention is directed to a method for monitoring data embedded in a video stream where the method includes receiving a video stream including embedded data, monitoring the video stream for the embedded data, storing information on the monitored data, and utilizing the monitored data for generating a report. The report may be financial reports, auditing reports, and the like. The data may include digital sound files, image files, subscription data, software programs, television program information, ITV advertising content, and the like.

According to another embodiment, the invention is directed to a system for monitoring data embedded in a video stream where the system includes a video stream including embedded data, a memory, and a data monitor coupled to the memory. The data monitor monitors the video stream for the embedded data and stores information on the monitored data in the memory for generating a report.

According to a further embodiment of the invention, the data monitor may be invoked from a remote location.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a schematic block diagram of a digital interactive television system for monitoring and logging data embedded in digital video streams according to one embodiment of the invention;

FIG. 2 is a block diagram of a monitoring system according to one embodiment of the invention;

FIG. 3 is a schematic block diagram of an exemplary user interface used to access the monitoring system of FIG. 2 according to one embodiment of the invention;

FIG. 4 schematically illustrates an exemplary interactive TV system in accordance with an exemplary embodiment of the present invention;

FIG. 5 is a schematic diagram that illustrates an API network interface in accordance with an exemplary embodiment of the present invention;

FIG. 6 is a schematic diagram that illustrates a system according to one illustrative embodiment of the invention; and

FIG. 7 is a schematic diagram that illustrates a user interface according to one illustrative embodiment of the invention.

### DETAILED DESCRIPTION

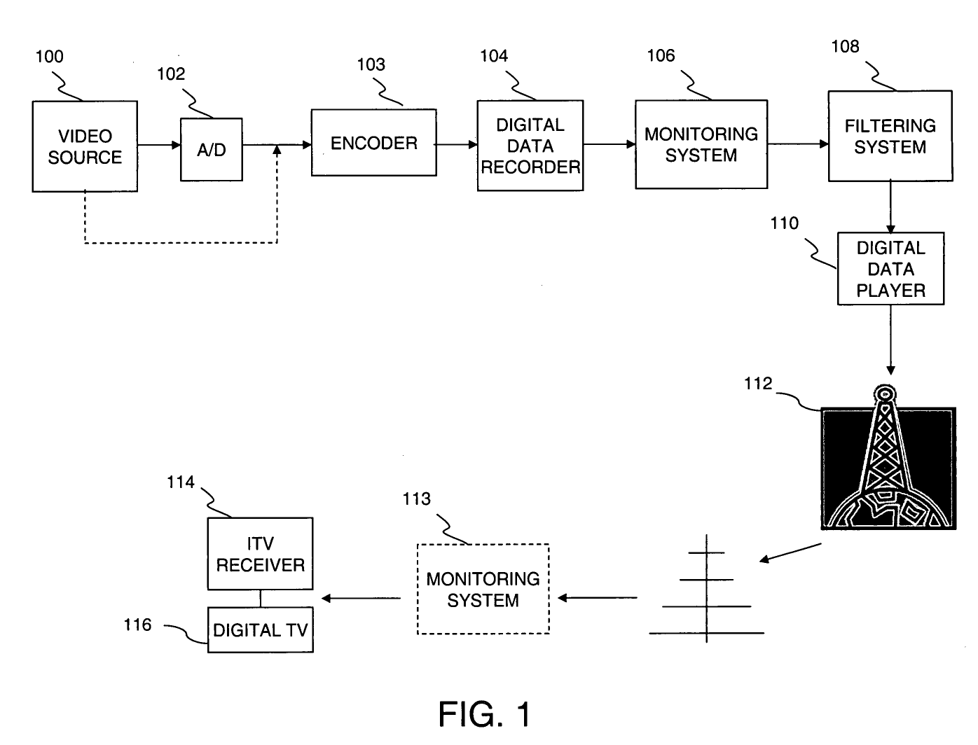

FIG. 1 is a schematic block diagram of a digital interactive television (ITV) system monitoring and logging data embedded in digital video streams according to one embodiment of the invention. The system preferably includes a video source 100 coupled to an analog/digital (A/D) converter 102 for converting analog video signals to digital video signals, such as, for example, MPEG streams. The video source 100 may be an analog camera, VCR, betacam, or the like, providing live or recorded analog video signals to the A/D converter 102. Alternatively, the video source 100 may be a digital video source such as, for example, a digital video camera, DVD player, PC, or CD-ROM player, configured to directly provide the digital video stream. In this scenario, the video feed need not be converted by the A/D converter.

The converted (or original) digital video signal is provided to an encoder 103 for embedding ITV data and other types of digital data into the video signal. The data may be embedded, for example, in an MPEG 2 private data field (or a similar field of additional video formats) of the video portion of the program. The ITV data may take many forms, such as, for example, HTML, XML, JAVA, or JAVA Script commands. In addition to ITV data, additional types of digital data may be embedded in the video stream. Such digital data may or may not be related to the video program that is being transmitted, and may include, without limitation, digital sound files, text files, image files, subscription data, software programs such as gaming programs and/or upgrades to such programs, television program information, soundtrack information, meta tags for storing/searching purposes, ITV advertising content, and the like.

Once the desired data is encoded into a video program, the modified program is output by the encoder 103 and may be recorded by a digital data recorder 104 for subsequent broadcast.

According to one embodiment of the invention, the digital ITV system includes a monitoring system 106 for receiving and monitoring different types of data embedded in the digital video. The monitoring system 106 preferably stores information about a pre-determined set of data that is being monitored, in one or more log files. The log files may then be used to generate a plurality of user defined reports. The reports may be used by broadcasters, cable operators, and content providers, and the like to establish general auditing, billing, financial, accounting, and/or distribution services.

The monitoring system may also generate specific reports that highlight particular data flows and/or particular periods of time that can then be correlated with content schedules for complete auditing trails. For example, the monitoring system 106 may monitor and log a number of MP3 audio files that have passed through a particular video stream in the last 24 hours. In another example, an amount of ITV advertising content that has passed through the video stream may be monitored, and in particular, the amount of advertising for individual advertisers.

In addition to the above, the monitoring system may examine the embedded data for ensuring that it is reliable for being transmitted with the video stream. For example, the monitoring system may maintain and monitor checksum information for different types of data packets to ensure that the data being delivered contains a correct checksum amount.

The digital ITV system illustrated in FIG. 1 may further include a filtering system 108 for filtering the digital video stream in accordance with a pre-defined criteria. For example, the filtering system 108 may filter the data embedded in the video stream prior to broadcast on the basis of a pass list containing data to be broadcast and a don't pass list containing data that is blocked when detected. For example, advertisers may embed ITV data in their commercials. However, if there is no agreement in place between a broadcaster/operator and the advertiser, the broadcaster/operator may want to monitor and block the embedded ITV data from being delivered with the commercials. At the appropriate time, the filtered digital video stream is then broadcast via a digital data player 110 and broadcast station 112.

According to one embodiment of the invention, the digital ITV system includes an optional monitoring system 113 on the receiving side of the broadcast station 112. The optional monitoring system 113 may be incorporated into an ITV receiver 114, antenna, satellite, or the like. The optional monitoring system 113 may be used to monitor a video stream broadcast by the broadcast station 112 to ensure that data associated with the video has not been corrupted during transmission. This may be done, for example, via checksum calculations and/or any other mechanisms conventional in the art. If the video stream is deemed to be reliable, the optional monitoring system 106 may transmit the stream to the ITV receiver 114 for providing to the viewer.

The optional monitoring system 113 may also provide similar functionality as the monitoring system 106 on the broadcast/operator side. However, instead of monitoring different types of data at an aggregate level, the optional monitoring system 113 may monitor data for individual users.

The ITV receiver 114 receives the digital video stream and decodes it for providing the video and associated information to a digital television 116. The digital television may alternatively be replaced by other digital devices capable of displaying video, such as, for example, a personal computer. The ITV receiver 114 further decodes any digital data embedded in the video stream and provides such data to the viewing user. The embedded data may be, for example, ITV data for providing an enhanced version of the video program to the viewer, and/or other types of audio, images, programs, information, and the like provided to the viewer in conjunction with the video program.

It is understood, of course, that FIG. 1 illustrates a block diagram of the digital ITV system without obfuscating inventive aspects of the present invention with additional elements and/or components which may be required for creating the system. These additional elements and/or components, which are not shown in FIG. 1, are well known to those skilled in the art.

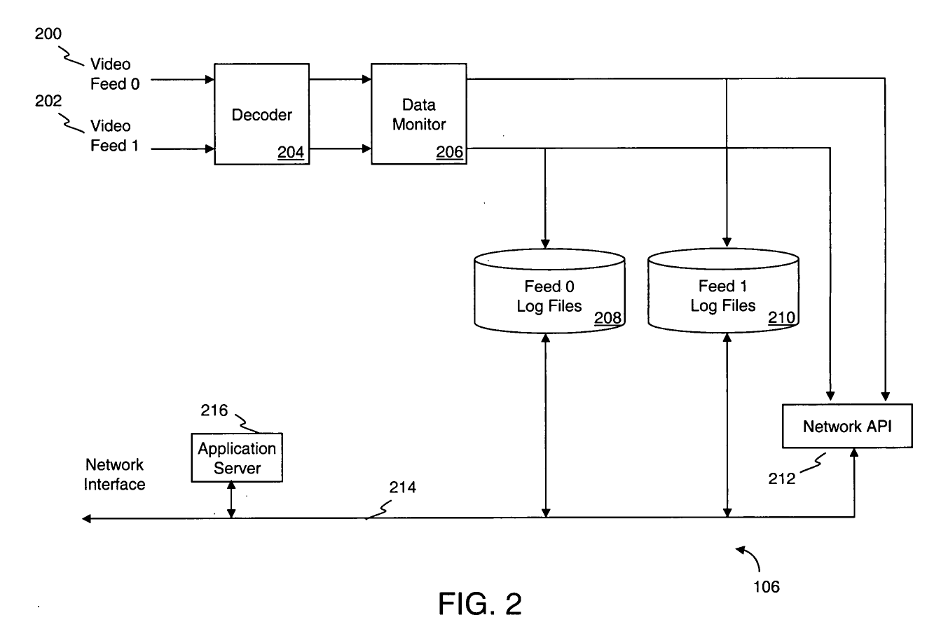

FIG. 2 is a more detailed block diagram of the monitoring system 106 according to one embodiment of the invention. According to the illustrated embodiment, the monitoring system 106 includes an embedded computer system running, for example, a Windows NT operating system. The monitoring system 106 monitors, identifies, and logs different types of data for a plurality of digital video feeds 200 and 202. When no video feed is detected, the monitoring system continues to operate properly by recording that no video is being received.

The monitoring system 106 includes a decoder 204 for decoding the digital data embedded in each video feed 200, 202. The decoded data is transmitted to a data monitor 206 for monitoring, identifying, and logging information on particular types of data. For example, the data monitor 206 may be on the lookout for a particular type of file format, size, data content, data source, meta data, or the like. The monitoring may occur in a real-time or play-back mode. During the play-back mode, the data monitor 206 logs the data in log files 208, 210, and plays back the logged data for a more in-depth analysis.

The data monitor 206 may also be configured to check the integrity of the embedded data. Information on the data being monitored is then stored in the appropriate log files 208, 210. The stored data may then be used for generating user defined reports, such as, for example, general auditing and financial reports.

According to one embodiment of the invention, the monitoring system 106 includes a network interface 214 providing bi-directional communication between an application server 216, a network application programming interface 212, and the logs files 208, 210. In the described embodiment, the application server 216 provides clients or users remote access to the data monitor 206 for allowing an administrator to view and change the monitoring system configuration. In one embodiment, a monitoring system user interface may be in the form of a web page or remote application that is delivered by the application server 216 to a web browser/user agent resident on a remote terminal (not shown) that is accessible to the administrator. In this regard, the administrator uses the remote terminal to access the application server 216. Upon establishing connection with the application server 216, a web page is delivered to the web browser/user agent resident in the remote terminal. According to one embodiment of the invention, the web page may contain a JAVA applet that opens a socket for allowing direct communication with the data monitor 206. In another embodiment, a remote application opens a socket using UDP for direct communication with the data monitor 206. According to a further embodiment of the invention, instead of the JAVA applet, the web browser may be used to communicate with the data monitor 206 via a hypertext transfer protocol (HTTP) in a manner that is conventional in the art.

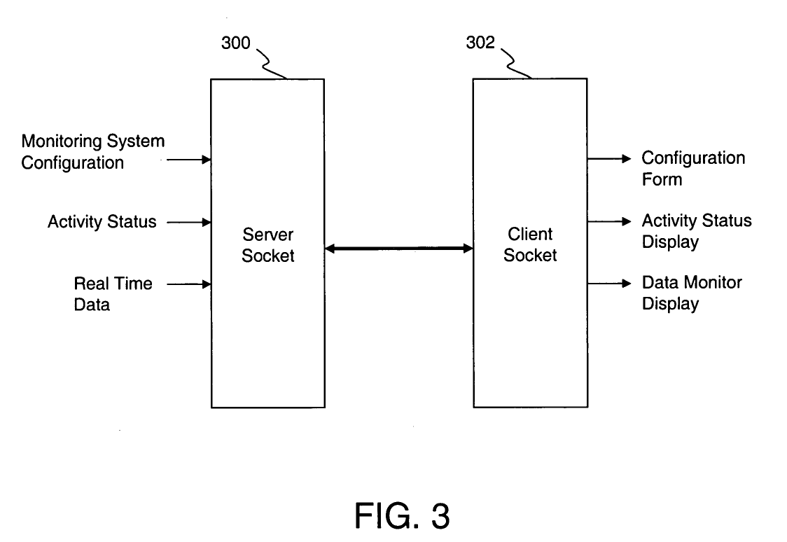

FIG. 3 is a schematic block diagram of an exemplary user interface used to access the monitoring system 106 according to one embodiment of the invention. The user interface preferably includes a server socket 300 and a client socket 302. The server socket 300 is preferably fed with the latest data monitoring information and real time data as it is acquired by the data monitor 206. The client socket 302 is preferably part of the user interface running on the browser resident on the remote terminal.

An exemplary user interface may allow remote users to view real time data and activity information with a plurality of monitoring windows. For example, client computers on the network may download a monitoring application provided by data monitors 206 from the web server 216 and use it to monitor the current data and activity information being acquired by the data monitor.

An exemplary embodiment of the present invention decodes and logs vertical blanking interval data associated with a video feed. An exemplary ITV monitoring system monitors a plurality of VBI data services including line 21 services such as closed captioning, V-chip, interactive TV and others. In order to appreciate the advantages of the present invention, it will be beneficial to describe the invention in the context of an exemplary ITV system.

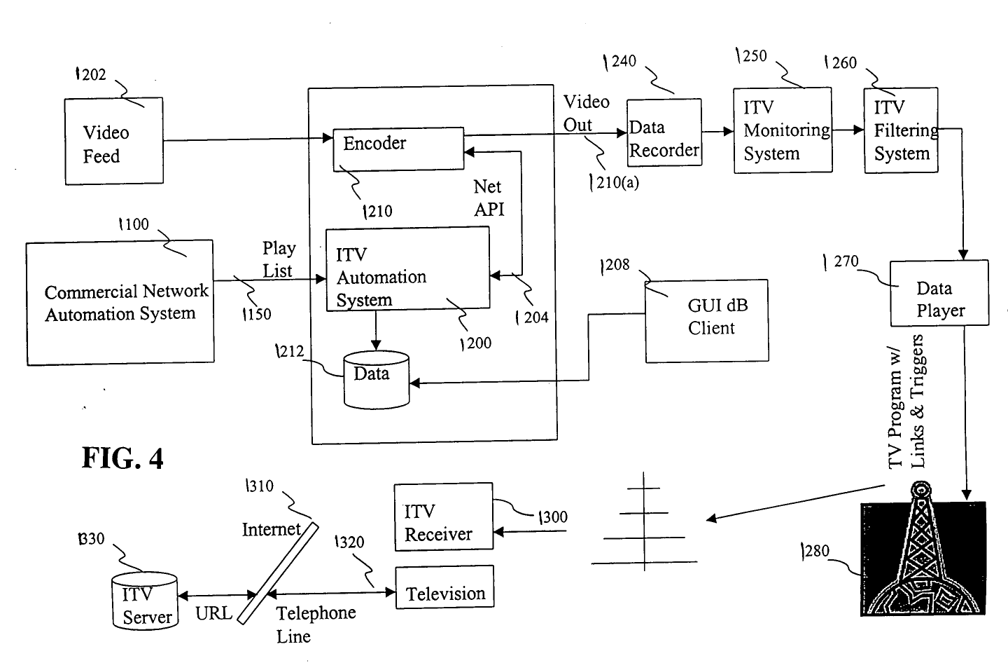

FIG. 4 illustrates the overall signal and data flow for an exemplary ITV system. During the production phase of a TV program or commercial, a video 1202 feed such as for example a live recording, or master recording may be coupled to a data encoder 1210 that embeds certain URL links and command triggers into the program, for example, in the vertical blanking interval (VBI) of the video portion of the program. In one illustrative embodiment, ITV automation system 1200 is designed to interface with the commercial network automation system 1100 to control the encoding of ITV links, triggers and data (ATVEF Transports A and B) into the video portion of the program. The Advanced Television Enhancement Forum (ATVEF) is a cross-industry alliance of companies representing the broadcast and cable networks, television transports, consumer electronics, and PC industries. This alliance of companies has defined protocols for Hypertext Markup Language (HTML)-based enhanced television, which allow content creators to deliver enhanced programming over all forms of transport (analog, digital, cable, and satellite) to any intelligent receivers.

In an exemplary embodiment the commercial network automation system 1100 periodically forwards a portion of a running playlist to ITV automation system 1200, through for example an RS-232 serial interface 1150 or other interfaces known in the art. In an exemplary embodiment, there is one such interface for each playlist (i.e., network feed). An exemplary ITV automation system 1200 reads and processes the playlist data and computes the links and data to be encoded and/or served, including any timecode offsets specified by the user. The ITV automation system 1200 feeds the links and data to a data encoder 1202 through for example a LAN application programming interface 1204 that embeds the various, links, triggers, etc. into the program.

The modified program output by the data encoder 1210(a) may be recorded by a data recorder 1240 for subsequent broadcast. In an exemplary embodiment, an ITV monitoring system 1250 may receive and monitor the recorded program for a plurality of VBI data services including line 21 services such as closed captioning, V-chip, interactive TV and others. An exemplary ITV monitoring system preferably stores the detected data services in a log file. These log files may then be used to generate a plurality of user defined reports. For example, an exemplary ITV monitoring system 1250 may be used by broadcasters, cable operators and content providers to establish general auditing and billing services as well agency compliance. Further, the ITV monitoring system 1250 can generate specific reports that highlight particular data services and or particular periods of time that can then be correlated with content schedules for complete auditing trails.

An exemplary ITV system may further include an ITV data management system 1260 that filters VBI data in real time in accordance with user defined criteria. For example, an exemplary ITV data management system 1260 may filter ITV data prior to broadcast on the basis of a pass list containing data to be broadcast and a don't pass list that contains data that is blocked when detected. An exemplary ITV data management system 1260 preferably decodes and filters closed caption and text services, V-chip as well as ATVEF transport type A and ATVEF transport type B encoded as IP over VBI. An exemplary ITV data management system may be configured to filter data services based upon content such as for example a particular URL or by time of day. In one embodiment an exemplary data management system may remove data services even if the service is multiplexed with other services in the same VBI line. For example, the data management system may remove ATVEF transport type A data from line 21 while preserving closed captions.

At the appropriate time the filtered TV program is broadcast, along with the embedded URLs and/or command triggers, by means of a data player 1270 and broadcast station 1280. These URLs and triggers cause an ITV receiver 1300 in a viewer's home to retrieve enhanced content from the Internet 1310 by way of a telephone interface 1320. The Internet, by way of the telephone interface provides two way communication between the viewer and an ITV web server 1330 at a content provider. An exemplary ITV web server 1330 is preferably designed for two-way communication with one or more user terminals. One of skill in the art will appreciate that the ITV web server is not limited to two communications over the Internet. Rather the present invention may communicate with one or more user terminals over any suitable communication network that provides for two-way communication of data. Often, the telephone interface provides the majority of the interactive content as the bandwidth reserved for ITV data in today's TV transmissions is very low. The TV program, along with the retrieved content, is displayed on a television or other suitable display, such as a computer display.

Typically, when a television program with available interactive TV content is first received, the viewer is given an option to receive the enhanced experience. If the viewer chooses the enhancements, the ITV receiver will establish a telephone connection to the Internet (if a connection is not already made), find the ITV web site based on a URL embedded in the television program, and then receive the content that produces the enhanced experience.

As is well known to those skilled in the art, the ITV data can take many different forms. For example, the ITV data can be a URL link that is utilized by the ITV receivers to access the corresponding web site. Alternatively, the ITV data can be a simple trigger or other command, which commands the ITV receiver to retrieve some interactive content. In that situation, the receiver is programmed to access a particular web site or other information provider, and to transmit a request for content, as is described in greater detail below. As used herein, the term “interactive content” is used to refer to any additional content which is retrieved from some source other than the TV signal itself, and that is intended to be displayed with a corresponding TV program to create an enhanced program.

As used herein, the term “ITV receiver” is intended to refer to set-top boxes, digital cable boxes, or any other suitable devices that have web browsing capabilities.

As is well known, ITV web servers 1330 are designed to handle various tasks based upon the information received from a user over the Internet 1310. For example, the information may be a request for content, incoming user registration information, user transaction information, or the like. ITV web servers 1330 are programmed to receive and process such requests.

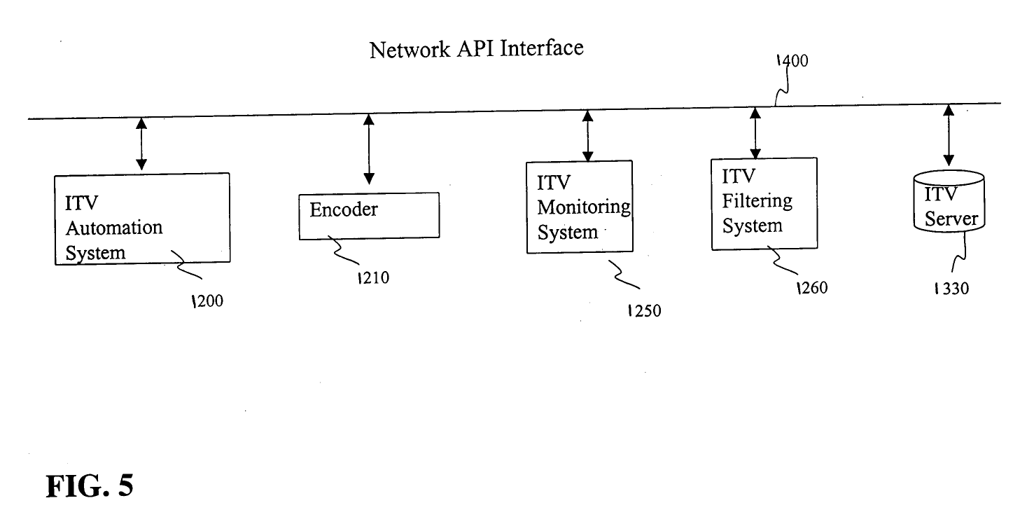

Referring to FIG. 5, in the described exemplary embodiment the ITV web server 1330, the data encoder 1210, the ITV data management system 1250, the ITV data monitoring system 1260 and the ITV automation system 1200 are connected for bi-directional communication over a private network interface 1400 in accordance with an exemplary application programming interface (API). The API interface provides for asynchronous command completion notification as well as concurrent request handling. An exemplary API utilizes a request response protocol wherein a channel ID and a request index is preferably included with each request. The channel ID and request index may be used to associate each response with an originating request. In operation, since each response may be uniquely identified, responses need not necessarily follows commands in the order in which they were received.

Further, in the described exemplary embodiment a request recorder is preferably included with each request. The request record may include a request type that identifies the requested function. Similarly, each response preferably includes a response record. The response record preferably includes a numeric result code that indicates the outcome of the request as well as a result flag that indicates whether the current response record is the final record or if more response records will follow. In the described exemplary embodiment any command may be acknowledged by returning a no error result code.

In the described exemplary embodiment, each request and response may be accompanied by a parameter buffer that is preferably at least as large (in bytes) as the associated request or response. The request and response records preferably include a field that indicates the size of the parameter buffer. The receiving application may then assume that each request/response sent or received has at least as many bytes as there are in the request or response record. Therefore, the receiving application can determine whether it has received the entire command or response by waiting for the fixed header size to arrive plus as many bytes as are specified in the result size or request size records.

Further, the API network interface allows a user to remotely interface with each of the content servers, and preferably with the ITV automation, monitoring and management systems. Thus remote groups of ITV automation, monitoring or management systems may be centrally monitored and controlled.

Further, in one embodiment real time encoding decisions may be supported by feedback from the ITV monitoring and management systems as well as the ITV web server. For example, in one embodiment, an exemplary ITV automation system may in real time or near real time, modify the VBI data that is encoded in a program in accordance with viewer responses that are received by the ITV web server. Similarly encoding decisions may also be modified, for example, in accordance with filtering results from the ITV data management system. Thus, the API network interface provides a closed loop system that may remotely tailor the data embedded into the video signal in accordance with external factors or events such as user responses.

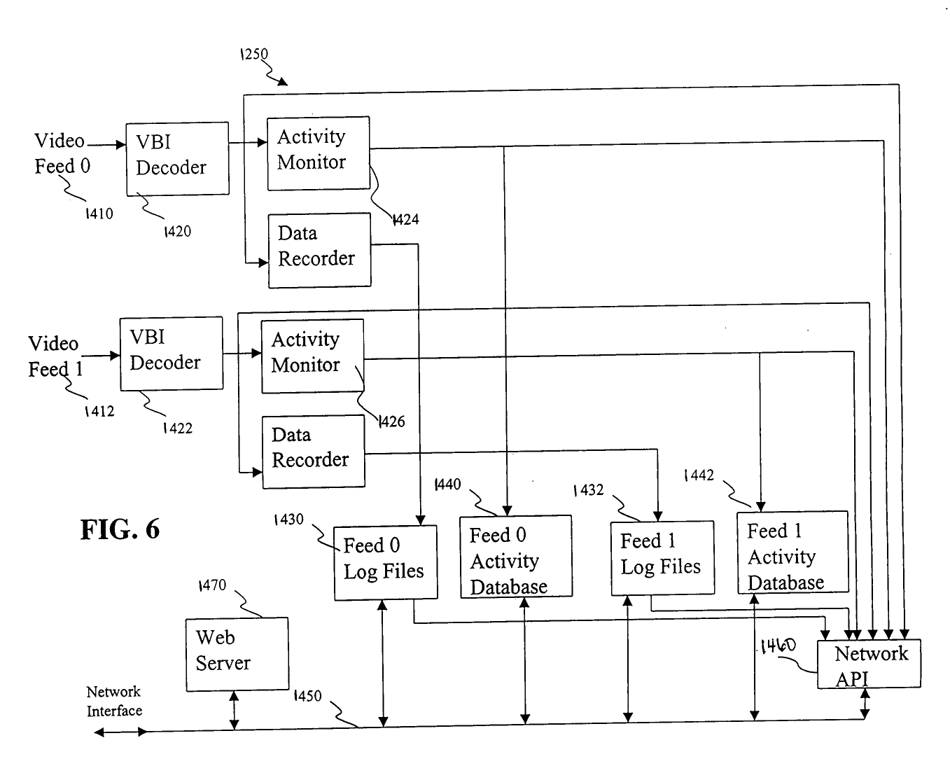

Referring to FIG. 6, in particular, and in one illustrative embodiment an exemplary ITV monitoring system preferably comprises a embedded computer system running for example Windows NT embedded operating system. An exemplary ITV monitoring system 1250 decodes monitors and logs all line 21 captioning and ATVEF type A and type B information for a plurality of video feeds 1410 and 1412. The video feeds may be for example NTSC analog composite video signals. The described exemplary embodiment preferably operates properly in the absence of a video input. In this instance an exemplary system preferably records that no video is being received.

In the described exemplary embodiment, the line 21 data acquired from each video feed is decoded 1420 and 1422 and stored in log files 1430 and 1432 on for example a hard drive in the monitoring system. One of skill in the art will appreciate that a plurality of storage devices may be used to store the acquired data so that the disclosed storage device is by way of example only and not by way of limitation. In an exemplary embodiment, the ITV monitoring system also monitors the decoded video feed for captioning activity. In one embodiment activity databases 1440 & 1442 may be used to store captioning activity information and to create closed captioning compliance reports for the FCC.

The ITV activity monitors 1424 and 1426 allow users to monitor the captioning and ATVEF type A and type B data being acquired from the video feeds in real time. The application may also re-play logged data that was recorded by the monitoring system. The activity monitor application may also allow users to view and change the ITV monitoring system configuration.

In the described exemplary embodiment network interface 450 provides bidirectional communication between the web server 1470, the network API 1460, and the log and activity database files 1430, 1432 and 1440, 1442. In the described exemplary embodiment the web server provides clients or users remote access to the ITV monitoring application. In one embodiment the ITV monitoring system user interface may be in the form of a web page that is delivered to a web browser from the web server. Users may then execute the user interface by accessing the IP address assigned to the appropriate ITV monitoring system. In an exemplary embodiment, when a user accesses the web server running on the ITV monitoring system a web page is delivered to their browser. The page may contain a JAVA applet that opens a socket to communicate directly with the acquisition applications.

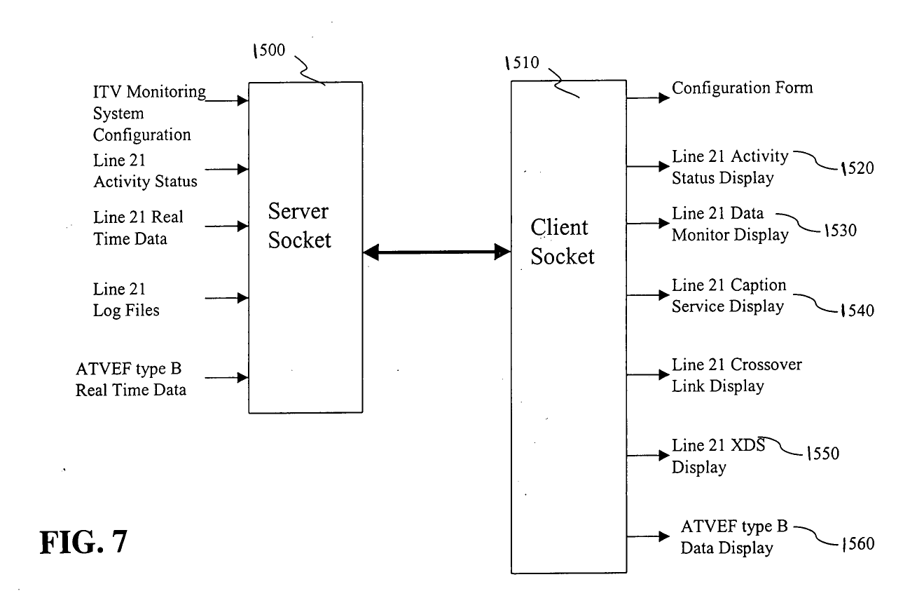

Referring to FIG. 7, an exemplary user interface preferably allows remote users to monitor the current data and activity information being acquired and to monitor and modify the configuration of the ITV monitoring system. The server socket 1500 is preferably fed with the latest activity status and real time data as it is acquired. The client socket 1510 is preferably part of the user interface running on a browser.

In an exemplary embodiment, the server socket preferably reads from the log files and reads/writes configuration data when requested by the client. Thus, a remote user may view current line 21 activity status 1520, as well as the line 21 data 1530 either real time or from line 21 logs. An exemplary embodiment further provides access to closed caption 1540, V-Chip 55, and ATVEF type B data as well 1540.

An exemplary user interface may also allow remote users to view real time or logged data with a plurality of monitoring windows. For example, client computers on the network may download the monitoring application form the web server and then use the monitoring application to monitor the current data and activity information being acquired. A user may also remotely “re-play” previously recorded data from the log files by specifying a data and time and inspect and change the configuration of the ITV monitoring system.

Although this invention has been described in certain specific embodiments, those skilled in the art will have no difficulty devising variations to the described embodiment which in no way depart from the scope and spirit of the present invention. Moreover, to those skilled in the various arts, the invention itself herein will suggest solutions to other tasks and adaptations for other applications. For example, although the present invention has been described in terms of detecting and logging digital data, a person skilled in the art will understand that the system may be modified to detect data in analog video signals. For example, the system may be configured to detect ITV data and closed captioning data embedded in the vertical blanking interval line (also known as line 21) of an analog video signal. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for remotely monitoring data embedded in a video signal, the method comprising:
establishing communication between a remote computer and an application server over a data communications network;
accessing a user interface provided to the remote computer by the application server and interfacing with a data monitor coupled to the application server, the data monitor monitoring one or more video signals and providing monitored data, the monitored data including data embedded in the one or more video signals;
transmitting the monitored data to the remote computer over the data communications network responsive to a user command transmitted via the user interface; and
displaying the monitored data on the remote computer.

2. The method of claim 1 further comprising logging the monitored data in a data store coupled to the data monitor.

3. The method of claim 1, wherein the monitored data is displayed on the remote computer in real time.

4. The method of claim 1, wherein the monitored data is closed captioning data.

5. The method of claim 1, wherein the monitored data is interactive television data.

6. The method of claim 1 further comprising changing configuration of the data monitor responsive to a user command transmitted from the remote computer via the user interface.

7. The method of claim 1 further comprising correlating the monitored data into a report.

8. The method of claim 1, wherein the one or more video signals are analog video signals.

9. The method of claim 1, wherein the one or more video signals are digital video signals.

10. A system for remotely monitoring data embedded in a video signal, the system comprising:
means for receiving one or more video signals including embedded data;
a data monitor coupled to the means for receiving, the data monitor monitoring the one or more video signals and providing monitored data, the monitored data including data embedded in the one or more video signals; and
an application server coupled to the data monitor, the application server providing a user interface for remotely interfacing with the data monitor, the application server transmitting the monitored data over a data communications network in response to a user command provided via the user interface.

11. The system of claim 10 further comprising:
a remote computer establishing communication with the application server over the data communications network, accessing the user interface provided by the application server, and interfacing with the data monitor via the user interface.

12. The system of claim 11, wherein the monitored data is displayed on the remote computer in real time.

13. The system of claim 11, wherein configuration of the data monitor is changed responsive to a user command transmitted from the remote computer via the user interface.

14. The system of claim 10, wherein the monitored data is closed captioning data.

15. The system of claim 10, wherein the monitored data is interactive television data.

16. The system of claim 10, wherein the data monitor correlates the monitored data into a report.

17. The system of claim 10, wherein the one or more video signals are analog video signals.

18. The system of claim 10, wherein the one or more video signals are digital video signals.

19. A method for remotely monitoring data embedded in a digital video stream, the method comprising:
establishing communication between a remote computer and an application server over a data communications network;
accessing a user interface provided to the remote computer by the application server and interfacing with a data monitor coupled to the application server, the data monitor monitoring one or more digital video streams and providing monitored data, the monitored data including data embedded in the one or more digital video streams;
transmitting the monitored data to the remote computer over the data communications network responsive to a user command transmitted via the user interface; and
displaying the monitored data on the remote computer.
